(19) United States
(12) Patent Application Publication
(10) Pub. No.: US 2026/0162445 A1
(43) Pub. Date: Jun. 11, 2026

(54) Apparatus and Method for Controlling a Child Lock of a Motor Vehicle

(71) Applicant: Bayerische Motoren Werke Aktiengesellschaft, Muenchen (DE)

(72) Inventors: Johannes Feldmaier, Ebersberg (DE); Simone Camberg, Muenchen (DE)

(21) Appl. No.: 19/126,029

(22) PCT Filed: Aug. 16, 2023
(86) PCT No.: PCT/EP2023/072517

§ 371 Date: Apr. 30, 2025

(30) Foreign Application Priority Data
Nov. 11, 2022 (DE) 10 2022 129 961.9

(51) Int. Cl. G06V 20/59; E05B 81/56; E05F 15/73; G06V 40/10; G06V 40/20; G08B 21/02

(52) U.S. Cl. CPC G06V 20/59; E05B 81/56; E05F 15/73; G06V 40/11; G06V 40/28; E05F 2015/767; E05Y 2900/55; G08B 21/0222

(57) ABSTRACT

An apparatus for controlling a child lock of a vehicle includes at least one camera of the vehicle and a control unit. The at least one camera is configured to capture at least one image having a depiction of an area of an interior of the vehicle and to generate image data corresponding to the at least one image. The control unit processes the image data to determine based on the image data whether an occupant actuates a central locking system of the vehicle, in order to ascertain based on the image data whether the occupant of the vehicle is a vulnerable person or a non-vulnerable person. The control unit executes a child lock function if it has ascertained that the occupant who actuates the central locking system is a vulnerable person.

The present application is the U.S. national phase of PCT Application PCT/EP 2023/072517 filed on Aug. 16, 2023, which claims priority of German patent application No. 10 2022 129 961.9 filed on Nov. 11, 2022, the entire contents of which are incorporated herein by reference.

### TECHNICAL FIELD

The disclosure relates generally to vehicles, and more particularly to controlling a child lock of a vehicle.

### BACKGROUND

Document EP 3 621 049 A1 discloses a system for operating a vehicle. The system is designed to prevent the locking of the vehicle when a passenger seat is occupied and a vehicle driver seat is not occupied.

Document US 2015/084759 A1 discloses a system for notifying a vehicle driver of a vehicle. The system is designed to notify the vehicle driver when a child or a pet has been left behind in the vehicle.

Document U.S. Pat. No. 6,922,622 B2 Discloses a Further System for operating a vehicle. The system is designed to inform a vehicle driver of a vehicle and control a climate control function of the vehicle when unattended children are located in the vehicle.

Central locking systems of vehicles often have operating elements, such as buttons in the vehicle interior or remote controls, which can easily be actuated by children. Therefore, a situation can rapidly occur in which a child inadvertently locks themself in a vehicle. For example, while an attending person briefly leaves the vehicle interior in order to help the child out of a child seat. If a key for the vehicle or a remote control for the central locking system are still located in the vehicle interior, the child is initially locked in. This is an unpleasant situation for the child and the attending person. Furthermore, vehicles can heat up very rapidly on sunny days. In particular for children locked in the vehicle, life-threatening situations can result therefrom. It is therefore in the interest of the parents to prevent children from locking themselves in vehicles.

There is an need, therefore, for a device and a method that controls a child lock of a vehicle which increase the level of safety for vulnerable persons in the vehicle interior.

### SUMMARY

The above-described need, as well as others, are addressed by at least some embodiments disclosed herein.

To this end, at least one embodiment for controlling a child lock of a vehicle comprises at least one camera of the vehicle, which is designed to capture at least one image having depiction of an area of the vehicle interior and to generate image data corresponding to the image. The device furthermore comprises a control unit which is designed to process the image data, to determine on the basis of c the image data whether an occupant actuates a central locking system of the vehicle, to ascertain on the basis of the image data whether the occupant of the vehicle is a vulnerable person, and to execute a child lock function if the control unit has ascertained that the occupant who actuates the central locking system is a vulnerable person.

A vulnerable person is predominantly understood in this application as a child, in particular an infant. However, an adult person who suffers from physical or mental impairments due to age or illness, for example, can also be a vulnerable person. A non-vulnerable person is a person that is not a vulnerable person.

The proposed device recognizes whether the occupant, who is actuating the central locking system of the vehicle, is a vulnerable person.

For this purpose, the control unit initially ascertains whether the central locking system was actuated. For example, the control unit can be designed to ascertain whether a locking command was given for the central locking system because an operating element of the central locking system was actuated. The control unit then initially ascertains, in the image of the vehicle interior captured by the camera, the occupant who has actuated the central locking system and whether r the occupant is a vulnerable person. If the device recognizes that a vulnerable person is actuating the central locking system, the control unit executes the child lock function. The child lock function prevents the vulnerable person from inadvertently being locked in the vehicle and/or the locked-in vulnerable person from coming to harm. Examples of the child lock function are described as embodiments of the invention. The vulnerable person is protected by the child lock function, by which the level of safety for the vulnerable person in the vehicle interior is increased.

In some embodiments, the control unit is designed to block the actuation of the central locking system as the child lock function when the control unit has ascertained that the occupant who actuates the central locking system is a vulnerable person. In this embodiment, the device deliberately prevents the vulnerable person from locking themself in the vehicle interior. A deliberate locking of the vehicle, for example by an attending person, is still possible, however. In this way, the level of safety of the vulnerable person and at the same time the user-friendliness are further increased.

In some embodiments, the control unit is designed to control a climate control function of the vehicle and/or to actuate a window lifter of the vehicle as the child lock function, in order to supply the vehicle interior with outside air when the control unit has ascertained that the occupant who actuates the central locking system is a vulnerable person. In particular, the control unit is designed to control the climate control function of the vehicle such that the temperature in the vehicle interior does not exceed a specific limiting value. In this embodiment, the device prevents the vehicle interior from heating up while the vulnerable person is locked in the vehicle interior. This prevents the locked-in vulnerable person from sometimes suffering severe damage to their health, such as heat stroke or worse, for example. The level of safety of the vulnerable person in the vehicle interior is also increased in this way.

The control unit can be designed in particular to block the actuation of the central locking system as the child lock function in a first operating mode and to control the climate control function of the vehicle and/or actuate the window lifter of the vehicle as the child lock function in a second operating mode. In particular, the control unit is designed such that a user can choose between the first operating mode and the second operating mode.

The control unit can also be designed to output a warning message as the child lock function when the control unit has ascertained that the occupant who actuates the central locking system is a vulnerable person. An attending person, in particular a vehicle driver and/or an attending person, for example a parent, of the vulnerable person can thus be warned by the warning message that the vulnerable person is locked in the vehicle. This prevents the vulnerable person from inadvertently being left behind in the vehicle. Since the attending person is given an alarm immediately, the time during which the vulnerable person is locked in the vehicle is furthermore shortened in this way. In such embodiments, the control unit can also be designed to delay the locking of the vehicle by a predetermined time if the control unit has ascertained that the occupant who actuates the central locking system is a vulnerable person. The predetermined time is in particular between 5 and 25 s, preferably 10 s. This gives the attending person enough time to react to the warning message.

In some embodiments, the control unit is designed to output the warning message to a mobile terminal. The warning message is preferably output to a mobile telephone, for example with the aid of a communication module of the control unit. For this purpose, for example, the contact data of a vehicle driver and/or owner can be stored in the storage area of the control unit. The attending person of the vulnerable person can thus also notice the warning message, even if they are not in the vicinity of the vehicle.

In particular, the control unit can also be designed to receive a control command from the mobile terminal in response to the warning message. For example, the control unit can receive a control command from the mobile terminal to unlock the central locking system, to activate the climate control function of the vehicle and/or to actuate the window lifter of the vehicle.

In some implementations, the control unit is designed to ascertain on the basis of the image data whether at least one further occupant is located in the vehicle interior when the control unit has ascertained that the occupant who actuates the central locking system is a vulnerable person, to ascertain on the basis of the image data whether the further occupant is an adult, and to only activate the child lock function if the control unit has ascertained that no further occupant is located in the vehicle interior or that the further occupant is also a vulnerable person. In this embodiment, the control unit checks whether an adult attending person is located with the vulnerable person in the vehicle interior. The control unit activates the child lock function only when no adult attending person is located in the vehicle interior. This prevents the child lock function from being inadvertently activated. This increases the user-friendliness of the device.

In other implementations, the device comprises a sensor of the vehicle, which is designed to detect a remote control of the central locking system in the vehicle interior and to generate sensor data corresponding to the detection. The control unit can be designed to process the sensor data, to determine on the basis of the sensor data whether the remote control of the central locking system is arranged in the vehicle interior, to ascertain whether a command to actuate the central locking system takes place via the remote control, and to activate the child lock function if the control unit has ascertained that the remote control of the central locking system is arranged in the vehicle interior and the command to actuate the central locking system has taken place via the remote control. The sensor is in particular an ultra-wideband sensor (UWB sensor). Alternatively, the device comprises multiple sensors which are arranged at various locations in the vehicle interior and are each designed to detect a radio signal originating from the remote control, so that the position of the remote control can be ascertained with the aid of triangulation, for example by the control unit. The remote control is in particular a key of the vehicle, which has operating elements for controlling the central locking System. Alternatively, the remote control can also be a mobile terminal, on which an application is executable, with the aid of which the vehicle is lockable and unlockable. Without the remote control, the attending person can only reopen the locked vehicle with difficulty. In this embodiment, the device therefore prevents the vulnerable person from being able to actuate the remote control in the vehicle interior when the vulnerable person is unattended, due to which the vulnerable person and the remote control would be locked in the vehicle interior. The level of safety of the vulnerable person is thus further increased.

In other embodiments, the camera is designed to capture multiple chronologically successive images with the depiction of the area of the vehicle interior and to generate image data corresponding to the images. The control unit can be designed to ascertain a movement of the occupant on the basis of the image data and to determine on the basis of the ascertained movement whether the occupant actuates the central locking system of the vehicle. In this embodiment, the camera captures an image sequence or video sequence. Movements, which the occupant executes with their hand, for example, can be better recognized from this sequence. To actuate the central locking system, the occupant has to execute a specific movement. For example, the occupant has to actuate an operating element for the central locking system, for example a button. Such a movement can be extracted from the sequence, for example using a suitable machine learning method. A particularly reliable ascertainment as to which occupant is actuating the central locking system is therefore possible.

In some embodiments, the control unit is designed to determine the position of at least one operating element of the central locking system, to ascertain a position of at least one arm of the occupant and a hand position of the hand of the arm on the basis of the image data, and to determine that the occupant actuates the central locking system of the vehicle if the hand position corresponds to the position of the operating element of the central locking system. The operating element is, for example, a button which can be arranged on a door inner side or a center console. If the hand position of the occupant corresponds to the position of the operating panel while the command for locking the central locking system is given, it can be concluded that the occupant has given the command. In this embodiment, it can therefore be ascertained very reliably which occupant has actuated the central locking system.

In some embodiments, the position of the operating element of the central locking system is stored in a storage area of the control unit. In this embodiment, the control unit ascertains the position of the operating element in that the control unit reads the position from the storage area. This is particularly advantageous if the position of the operating element in the vehicle interior is fixed in place, for example if the operating element is a button arranged fixedly in the vehicle interior.

In some implementations, the device comprises a or the sensor of the vehicle, which is designed to detect the position of a or the remote control of the central locking system in the vehicle interior and to generate position data corresponding to the position. The control unit is designed to process the position data and to ascertain the position of the operating element of the central locking system on the basis of the position data. In this embodiment, the control unit ascertains the position of the operating element with the aid of the sensor. A very accurate determination of the position of the operating element is enabled in this way.

In some embodiments, the control unit is designed to determine the position of the operating element of the central locking system on the basis of the image data. This is advantageous in particular if the operating element is not arranged fixed in place in the vehicle interior, for example if the operating element is vehicle key having a remote control for the central locking system. The position of the operating element can then be determined very accurately from the image data.

The control unit can be designed to ascertain the position of the arm and/or the hand position on the basis of the image data and using a human pose estimation method. The position of the arm in such cases is reliably ascertained as a three-dimensional vector from the two-dimensional image of the camera by the human pose estimation method. In particular, the hand position can also be ascertained, even if it is not visible in the image. Therefore, the control unit can also reliably ascertain in the present case whether the hand position corresponds to the position of the operating element of the central locking system if the position of the operating element is not visible on the image. If the camera is designed to capture multiple chronologically successive images, the hand position can also be tracked with the aid of the human pose estimation method. In particular, the movement of the hand position in the vehicle interior can also be tracked further, even if the hand is briefly not visible in the image captured by the camera. In this way, even if the position of the operating element is not visible on the image, it can be reliably determined which occupant is actuating the operating element.

In some embodiments, the control unit is designed to ascertain on the basis of the image data and using a machine learning method whether the occupant is a vulnerable person. In particular, the machine learning method is an age classification method. Alternatively or additionally, the height of the occupant can also be determined with the aid of the human pose estimation method. A classification of the occupant as child or adult can then take place, for example, on the basis of the height of the occupant. In order to make the classification of the occupant even more reliable, further features can be extracted from the image of the camera. For example, it can be determined with the aid of a suitable machine learning method whether the occupant is sitting in a child seat or the like, or their age can be concluded from the clothing style of the occupant. The control unit can furthermore use, in addition to the image data, sensor data from further sensors arranged in the vehicle interior, in particular from a UWB sensor, to make the classification of the occupant more reliable.

The respiratory frequency and the pulse of the occupant can be ascertained very accurately with the aid of a UWB sensor, for example. A classification of the occupant can take place even more reliably using this information. Furthermore, the occupant can be localized very accurately in the vehicle interior with the aid of a UWB sensor. In particular, the control unit can also use a facial recognition method in order to perform a classification of the occupant. For example, known facial recognition methods can perform a classification of the occupant as child or adult. In addition, facial recognition methods can be trained, for example by a vehicle owner, in order to recognize a vulnerable person even if the vulnerable person is not a child. Machine learning methods can reliably classify humans as children and adults. The use of a machine learning method makes the ascertainment as to whether the occupant who actuates the central locking system is a vulnerable person particularly reliable.

Some embodiments include a method for controlling a child lock of a vehicle. In the method, at least one image having a depiction of an area of the vehicle interior is captured. Image data corresponding to the image are generated. It is determined on the basis of the image data whether an occupant actuates a central locking system of the vehicle. It is ascertained on the basis of the image data whether the occupant of the vehicle is a vulnerable person. Furthermore, a child lock function is executed if it has been ascertained that the occupant who actuates the central locking system is a vulnerable person.

The method has the same advantages as one or more of the embodiments described above.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective schematic representation of a cockpit of a vehicle;

FIG. 2 shows a schematic representation of an image of the interior of the vehicle that is recorded by the camera;

FIG. 3 shows a schematic representation of a further image of the vehicle interior that is recorded by the camera; and

FIG. 4 shows the flow chart of the method for controlling the child lock of the vehicle.

### DETAILED DESCRIPTION

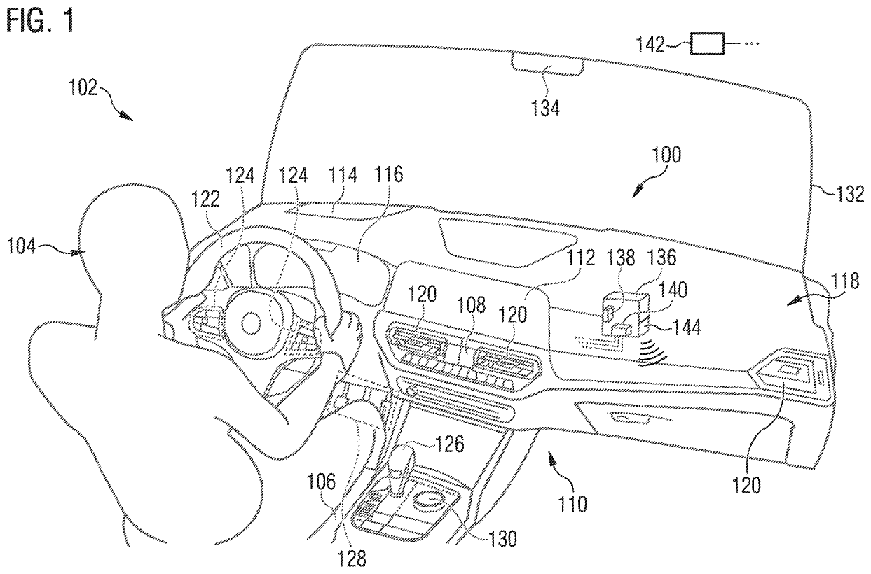

FIG. 1 shows a perspective schematic representation of a cockpit 100 of a vehicle.

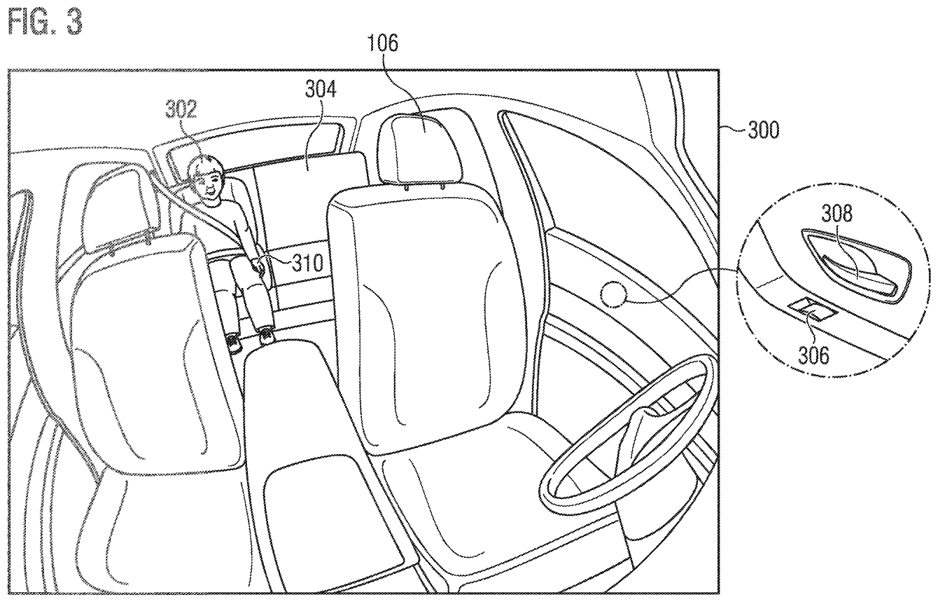

A vehicle driver 104 sits on a driver seat 106 of the vehicle 102. A button 108 for actuating a central locking system of the vehicle 102 is arranged, for example, in the area of a center console 110 of the cockpit 100. Further buttons can be arranged, for example, in the area of a door handle 308 on the inner side of a door of the vehicle 102 (cf. FIG. 3). The cockpit 100 moreover comprises a central information display (CID) 112, a head-up display 114 and a graphic instrument cluster 116, which are arranged on a dashboard 118 of the vehicle 102.

The dashboard 118 furthermore comprises air outflow nozzles 120 of a climate control system of the vehicle 102. Air outflow nozzles 120 are shown by way of example in the area of the center console 110 and on a front passenger side in FIG. 1. The cockpit 100 furthermore comprises a steering wheel 122 having operating elements 124, a gear selection switch 126, a pedal set 128 and an input unit 130 having a rotating wheel and a pushbutton function and/or a touch input panel. This input unit 130 is also referred to as an ergo commander.

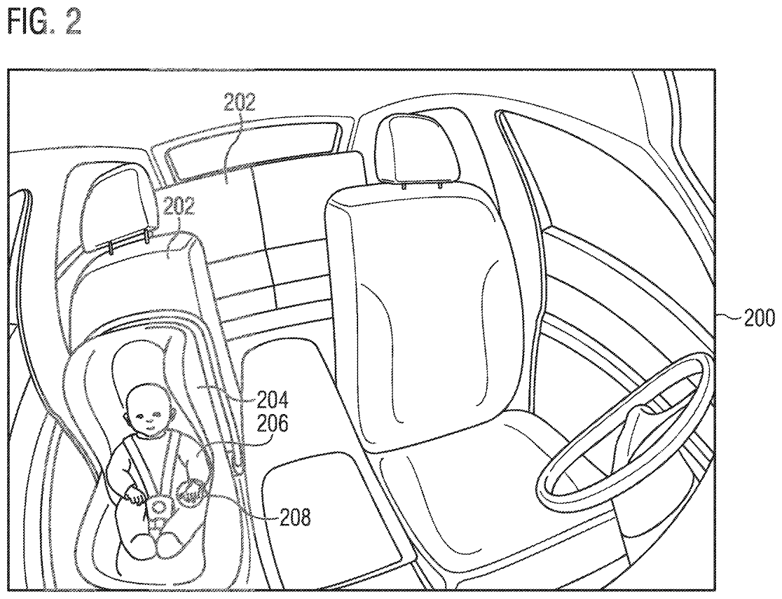

A camera 134 is arranged in the upper area of a windshield 132 of the vehicle 102. The camera 134 is arranged and aligned such that the camera 134 can capture images 200, 300 having a depiction of an area of the interior of the vehicle 102. Exemplary images of the camera 134 are described hereinafter on the basis of FIGS. 2 and 3. The camera 134 is designed in particular to capture multiple chronologically successive images, to generate image data corresponding to the images 200, 300, and to transmit said image data to a control unit 136.

The control unit 136 has data outputs 138 and data inputs 140, which are used for the connection to further units of the vehicle 102, for example to further sensors, input and output units, and control units of assistance systems. In particular, the control unit 136 is connected to a sensor 142 which is designed to detect a remote control of the central locking system, for example a key of the vehicle 102, in the vehicle interior. The control unit 136 furthermore comprises a communication module 144 which is designed to establish a connection to a telecommunication network, in particular a cellular network.

The control unit 136 is designed to carry out a method for controlling a child lock of the vehicle 102. In the method, it is determined with the aid of the camera 134 whether a vulnerable person actuates the central locking system of the vehicle 102, for example, in that the vulnerable person actuates the button 108 of the central locking system or locks the central locking system with the aid of the remote control. If it has been ascertained that the vulnerable person actuates the central locking system, the control unit 136 executes a child lock function. For example, the control unit 136 can block the actuation of the central locking system to prevent the vulnerable person from being locked in the vehicle 102. Alternatively, the control unit 136 can also control the climate control system of the vehicle 102 and/or actuate a window lifter of the vehicle 102 in order to supply the vehicle interior with outside air and prevent the vehicle 102 from heating up above a predetermined temperature limiting value. In particular, the control unit 136 is designed to output a warning message to a mobile terminal as the child lock function with the aid of the communication module 144, in order to alert an attending person. The method will be described in more detail hereinafter on the basis of FIGS. 2 to 4.

FIG. 2 shows a schematic representation of an image 200 of the interior of the vehicle 102 that is recorded by the camera 134.

The camera 134 has a field of view of 120 degrees. In other embodiments, the camera 134 can also have a field of view in the range of 150 degrees or more. The camera 134 is oriented in the direction of the driver seat 106 and a front passenger seat 202 of the vehicle 102. A child seat shell 204, in which an infant 206 is seated, is arranged on the front passenger seat 202 of the vehicle 102. The infant 206 is a vulnerable person. No further occupant is located in the vehicle interior except for the infant 206. In other words, the infant 206 is unattended in the vehicle interior. The infant 206 holds the key to the vehicle 102 in their hand 208.

In the exemplary embodiment shown, the control unit 136 is designed to ascertain the position of the key in the vehicle interior. For this purpose, the control unit 136 can process sensor data, for example, which are generated by the sensor 142. Alternatively or additionally, the control unit 136 can process image data generated by the camera 134 in order to determine the position of the key and therefore of the remote control of the central locking system.

If the control unit 136 receives a command to lock the central locking system, the control unit 136 ascertains which occupant of the vehicle 102 has given the command in order to activate the child lock function if necessary. In the exemplary embodiment shown in FIG. 2, for this purpose, the control unit 136 initially ascertains that the command for locking was given with the aid of the remote control of the central locking system. The control unit 136 then ascertains the position of the remote control in the vehicle interior. On the basis of the image data of the camera 134, the control unit 136 then ascertains that the only occupant is the infant 206 and that the infant 206 holds the remote control of the central locking system in their hand 208. In order to ascertain the position of the hand 208 of the infant 206 from the image data, the control unit 136 carries out a human pose estimation method. Since the control unit 136 has ascertained that the command to lock was given via the remote control of the central locking system and that the infant 206 holds the key and therefore the remote control in their hand, the control unit 136 determines that the infant 206 has given the command to lock the central locking system. Since the infant 206 has actuated the central locking system, the control unit 136 then executes the child lock function.

FIG. 3 shows a schematic representation of a further image 300 of the vehicle interior that is recorded by the camera 134.

In the situation shown in FIG. 3, a child 302 is seated on a rear seat bench 304 of the vehicle 102. The child 302 is a vulnerable person. Except for the child, no further occupant is located in the vehicle interior.

The button 108 for actuating the central locking system is arranged on the center console 110. This button 108 is not visible in the image 300 of the camera 134. A further button 306 for actuating the central locking system is arranged in the area of a door handle 308 of the door on the driver side. This second button 306 is visible in the image of the camera 134. The two buttons 108, 306 are operating elements of the central locking system that are arranged fixed in place in the interior. The position of each of the two buttons 108, 306 is stored in a storage area of the control unit 136.

The control unit 136 can ascertain from the image data of the camera 134 that the single occupant is the child 302. If the child 302 actuates one of the two buttons 108, 306, for example in that the child 302 leans forward into the area of the driver seat 106, the control unit 136 initially receives the command to lock the central locking system. The control unit 136 then ascertains from the image data the position of an arm of the child and a position of a hand 310 of the child. Thereupon, the control unit 136 then compares the hand position to the stored positions of the buttons 108, 306 in order to determine whether the child has actuated the central locking system. The control unit 136 can in particular also determine here with the aid of the human pose estimation method the position of the hand 310 of the child when said hand is not visible in the image of the camera 134. In this way, the control unit 136 can ascertain, for example, whether the hand position of the child corresponds to the position of the button 108 on the center console 110, which is not visible on the image 300 of the camera 134. If the control unit 136 has ascertained that the child 302 has actuated one of the buttons, the control unit 136 executes the child lock function.

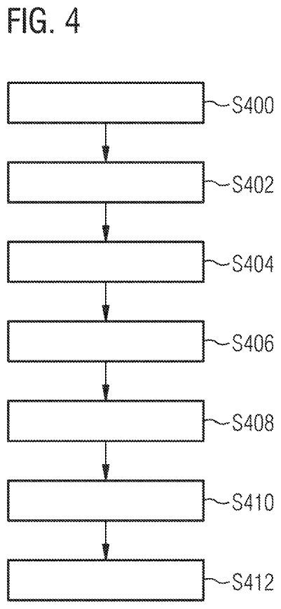

FIG. 4 shows the flow chart of the method for controlling the child lock of the vehicle 102.

The method is started in step S400. The method is in particular started when the control unit 136 receives a command to lock the central locking system. In step S402, the control unit 136 controls the camera 134 such that the camera 134 captures at least one image 200, 300 having a depiction of the vehicle interior. The image data corresponding to the image are generated by the camera 134 and transmitted to the control unit 136. In step S404, the control unit 136 determines on the basis of the image data which occupant actuates the central locking of the vehicle 102. In particular, the control unit 136 determines for this purpose a position of an arm and a hand position for each occupant, for example using a human pose estimation method or another suitable machine learning method. The control unit 136 can then determine which occupant is actuating the central locking system from the comparison of the hand position to the position of the operating element of the central locking system, which is stored in the storage area of the control unit 136 or ascertained from the image data or sensor data.

In step S406, the control unit 136 then ascertains on the basis of the image data whether the occupant who is actuating the central locking system of the vehicle 102 is a child 206, 302 or an adult. This ascertainment can take place in particular with the aid of a facial recognition method or another suitable machine learning method. If the control unit 136 has ascertained that an adult actuates the central locking system, the method is ended after step S406.

If the control unit 136 has ascertained that a child 206, 302 actuates the central locking system, the control unit 136 then ascertains in optional step S408 whether an adult attending person is located with the child 206, 302 in the vehicle interior. In step S410, the control unit 136 then executes the child lock function, in particular if no adult attending person is located with the child 206, 302 in the vehicle interior. As the child lock function, the control unit 136 can, for example, block the actuation of the central locking system and therefore prevent the child 206, 302 from locking themself in the vehicle interior. The control unit 136 can also control the climate control system of the vehicle 102 to prevent the vehicle 102 from heating up, and/or can actuate a window lifter of the vehicle 102 in order to supply the vehicle interior with outside air. Finally, the control unit 136 can additionally output a warning message to a mobile terminal with the aid of the communication module 144s in order to alert an attending person. The method is ended in step S412.

In the exemplary embodiments described on the basis of FIGS. 1 to 4, the camera 134 and the control unit 136 form a device for controlling a child lock of the vehicle 102. Further elements and features shown in FIGS. 1 to 4 and mentioned in the preceding description can be part of this device.

### LIST OF REFERENCE SIGNS

100 cockpit
102 vehicle
104 vehicle driver
106 driver seat
108 button
110 center console
112, 114, 116 display element
118 dashboard
120 air outflow nozzles
122 steering wheel
124 operating element
126 gear selection switch
128 pedal set
130 input unit
132 windshield
134 camera
136 control unit
138 data output
140 data input
142 sensor
200 image
202 front passenger seat
204 child seat shell
206 infant
208 hand
300 image
302 child
304 rear bench seat
306 button
308 door handle
310 hand

1.-15. (canceled)

16. An apparatus for controlling a child lock of a vehicle, comprising:
at least one camera of the vehicle, which is configured to capture at least one image having a depiction of an area of an interior of the vehicle and to generate image data corresponding to the at least one image,
a control unit which is configured to process the image data, to determine based on the image data whether an occupant actuates a central locking system of the vehicle, to ascertain based on the image data whether the occupant of the vehicle is a vulnerable person or a non-vulnerable person, and to execute a child lock function if the control unit has ascertained that the occupant who actuates the central locking system is a vulnerable person.

17. The apparatus as claimed in claim 16, wherein the control unit is configured to block the actuation of the central locking system as the child lock function if the control unit has ascertained that the occupant who actuates the central locking system is a vulnerable person.

18. The apparatus as claimed in claim 16, wherein the control unit is configured to cause at least one operation to be performed as the child lock function to supply the interior with outside air if the control unit has ascertained that the occupant who actuates the central locking system is a vulnerable person.

19. The apparatus as claimed in claim 18, wherein the at least one operation includes controlling a climate control function of the vehicle as the child lock function.

20. The apparatus as claimed in claim 18, wherein the at least one operation includes actuating a window lifter of the vehicle.

21. The apparatus as claimed in claim 16, wherein the control unit is configured to output a warning message as the child lock function if the control unit has ascertained that the occupant who actuates the central locking system is a vulnerable person.

22. The apparatus as claimed in claim 21, wherein the control unit is configured to output the warning message to a mobile terminal.

23. The apparatus as claimed in claim 16, wherein the control unit is configured to:
ascertain based on the image data whether at least one further occupant is located in the interior if the control unit has ascertained that the occupant who actuates the central locking system is a vulnerable person;
ascertain based on the image data whether the at least one further occupant is a non-vulnerable person, and
activate the child lock function only if the control unit has ascertained that no further occupant is located in the interior, or that the at least one further occupant is a non-vulnerable person.

24. The apparatus as claimed in claim 23, further comprising a sensor of the vehicle, which is configured to detect a remote control of the central locking system in the interior and to generate sensor data corresponding to detection of the remote control, and wherein:
the control unit is configured to process the sensor data, to determine based on the sensor data whether the remote control of the central locking system is arranged in the interior, to ascertain whether a command to actuate the central locking system has been generated via the remote control, and to activate the child lock function if the control unit has ascertained that the remote control of the central locking system is arranged in the interior and the command to actuate the central locking system has been generated via the remote control.

25. The apparatus as claimed in claim 16, wherein:
at least a first camera of the at least one camera is configured to capture multiple chronologically successive images having the depiction of the area of the interior and to generate the image data corresponding to the successive images; and
the control unit is configured to ascertain a movement of the occupant based on the image data and to determine based on the ascertained movement whether the occupant actuates the central locking system of the vehicle.

26. The apparatus as claimed in claim 16, wherein the control unit is configured to determine a position of at least one operating element of the central locking system, to ascertain a position of at least a first arm of the occupant and a hand position of a hand of the first arm based on the image data, and to determine that the occupant actuates the central locking system of the vehicle if the hand position corresponds to the position of the at least one operating element of the central locking system.

27. The apparatus as claimed in claim 26, wherein the position of the at least one operating element of the central locking system is stored in a storage area of the control unit.

28. The apparatus as claimed in claim 27, further comprising a sensor of the vehicle, which is configured to detect the position of a remote control of the central locking system in the interior and to generate position data corresponding to the position of the remote control, and wherein the control unit is configured to process the position data and to ascertain the position of the at least one operating element of the central locking system based on the position data.

29. The apparatus as claimed in claim 26, further comprising a sensor of the vehicle, which is configured to detect the position of a remote control of the central locking system in the interior and to generate position data corresponding to the position of the remote control, and wherein the control unit is configured to process the position data and to ascertain the position of the at least one operating element of the central locking system based on the position data.

30. The apparatus as claimed in claim 26, wherein the control unit is configured to determine the position of the at least one operating element of the central locking system based on the image data.

31. The apparatus as claimed in claim 26, wherein the control unit is configured to ascertain the hand position based on the image data using a human pose estimation method.

32. The apparatus as claimed in claim 16, wherein the control unit is configured to ascertain based on the image data using a machine learning method whether the occupant is a vulnerable person.

33. A method for controlling a child lock of a vehicle, the method comprising capturing at least one image having a depiction of an area of an interior of the vehicle;
generating image data corresponding to the at least one image;
determining, based on the image data whether an occupant actuates a central locking system of the vehicle;
determining, based on the image data whether the occupant of the vehicle is a vulnerable person; and
performing a child lock function if it has been determined that the occupant who actuates the central locking system is a vulnerable person.
